(19) United States
(12) Patent Application Publication
(10) Pub. No.: US 2004/0204143 A1
(43) Pub. Date: Oct. 14, 2004

(54) Method for showing caller's horoscope index in cellular phone and cellular phone displaying caller's horoscope index

(75) Inventor: James Chen, Hsinchu (TW)

Correspondence Address: BACON & THOMAS, PLLC, 625 SLATERS LANE, FOURTH FLOOR, ALEXANDRIA, VA, 22314

(73) Assignee: LITE-ON TECHNOLOGY CORPORATION, Taipei (TW)

(21) Appl. No.: 10/411,251

(22) Filed: Apr. 11, 2003

(30) Foreign Application Priority Data
Nov. 26, 2002 (TW) 0911134295

(51) Int. Cl. H04M 3/42

(52) U.S. Cl. 455/566; 455/414.1

(57) ABSTRACT

The present invention relates to a method for showing a caller's horoscope index in a cellular phone, which comprises the steps of establishing a horoscope index database in the cellular phone, storing the caller's birth month and day in the cellular phone, checking the caller's horoscope index according to a caller's birth month and day and current date by inquiring a horoscope index database stored in the cellular phone, and finally, displaying a picture representing the caller's horoscope index on the screen of the cellular phone.

The present invention also relates to a cellular phone displaying caller's horoscope index on a screen thereof. Therefore, the cellular phone according to the present invention can be more interesting on phone communication.

### FIELD OF THE INVENTION

The present invention relates to a method for showing a caller's horoscope index in a cellular phone and a cellular phone displaying a caller's horoscope index. In particularly, the present invention relates to a method for showing a caller's horoscope index in a cellular phone in which the index is displayed as a picture and a cellular phone using this method.

### TECHNICAL BACKGROUND

It is a great improvement recently on a cellular phone in regard to modeling, function, and display style. A new cellular phone is always designed to cater for a customer's requirements. Today, cellular phone is not simply used for communication. Therefore, various kinds of ring, color, shape and picture styles have been developed.

New generation is interested in love constellation. The love fate, enterprise fate and so on associated with the constellation are popular by the young man.

Therefore, if the constellation is incorporated into a cellular phone and a caller's horoscope is shown as pictures displayed on the screen of a cellular phone, such kind of cellular phone will be more popular.

### SUMMARY OF THE INVENTION

One object of the present invention is to provide a method for showing a caller's horoscope index in a cellular phone, the method comprises the steps of establishing a horoscope index database in the cellular phone, storing the caller's birth month and day in the cellular phone, checking the caller's horoscope index according to a caller's birth month and day and current date by inquiring the horoscope index database established in the cellular phone, and displaying pictures representing the caller's horoscope index on the screen of the cellular phone. Therefore, the cellular phone according to the present invention can be more interesting and popular.

The other object of the present invention is to provide a cellular phone showing a caller's horoscope index therein, only a horoscope index database is needed to be built in the cellular phone so that it doesn't increase the weight of the cellular phone.

These objects and the other objects, features, and advantages will be apparent to those people skilled in the art from the following detailed description in connection with the drawings.

### BRIEF DESCRIPTION OF THE DRAWINGS

FIG. 1 is a circuit block diagram showing a structure of a cellular phone with a horoscope index database according to an embodiment of the present invention;

FIG. 2 is a flow chart showing the procedures for adding a new data in a cellular phone according to an embodiment of the present invention;

FIG. 3 is a flow chart showing the procedures for activating or deactivating the method for showing a caller's horoscope index in a cellular phone according to an embodiment of the present invention;

FIG. 4 is a flow chart showing the operation procedures for showing a caller's horoscope index as a picture in a cellular phone according to an embodiment of the present invention;

FIG. 5 shows pictures corresponding to steps in FIG. 4; and

Table 1 lists one example of a database of daily horoscope index based on horoscope database.

### DETAILED DESCRIPTION OF THE INVENTION

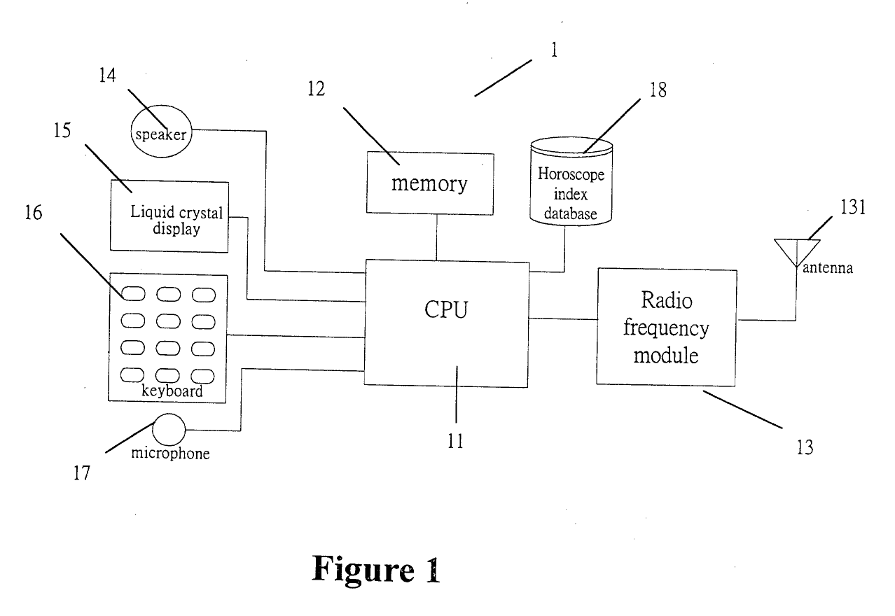

First of all, please refer to FIG. 1. FIG. 1 shows the circuit structure of a cellular phone for showing a caller's horoscope index in the cellular phone according to an embodiment of the present invention. From FIG. 1, it is known that the present cellular phone 1 mainly comprises a central processing unit (CPU) 11, memory 12, radio frequency module 13, antenna 131, speaker 14, liquid crystalline displaying (LCD) screen 15, keyboard 16, and microphone 17. Additionally, the cellular phone according to the present invention further includes a horoscope index database 18 installed therein. The horoscope index database 18 is used for being inquired about horoscope indexes. The entire procedures for checking a caller's horoscope index are as follows. A user first stores the caller's birth month and day in the memory 12. The central processing unit 11 inquires about the caller's horoscope index stored in the horoscope index database 18 according to the caller's birth month and day and a current day. Then a picture for representing the caller's horoscope index is displayed on the screen 15 of the cellular phone.

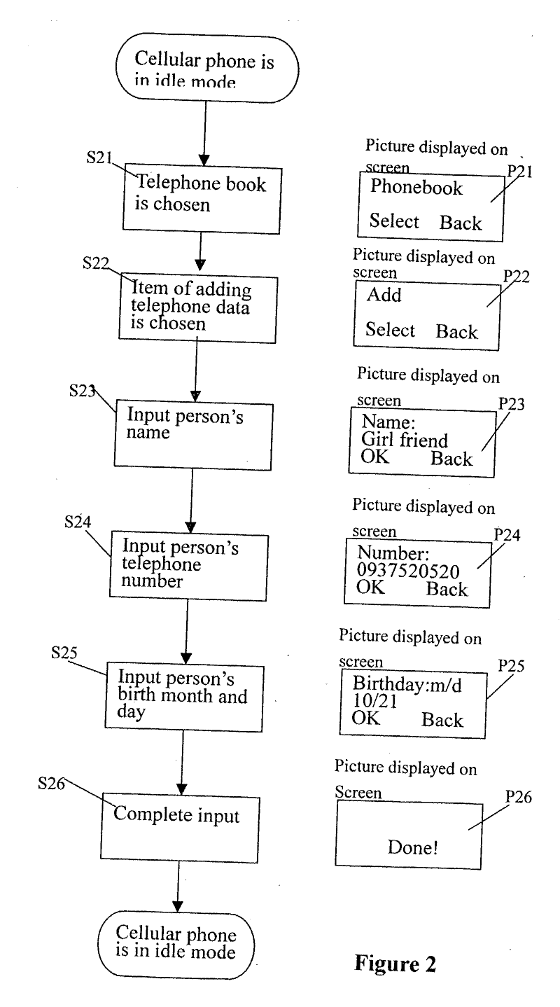

Next, please refer to FIG. 2. FIG. 2 is a flow chart showing steps for adding new data in a cellular phone; a picture displayed on the screen accompanied with the each corresponding step is also shown in the figure. The steps for adding new data in the cellular phone are as follows. First, the cellular phone is in an idle mode. When a user wants to add a new telephone data, he chooses a telephone book function in the cellular phone (step S21, picture P21), and then select item of adding telephone data (step S22, picture P22). Thereafter, the user inputs a person's name to be added (step S23, picture P23: Girl Friend) and then inputs the person's telephone number (step S24, picture P24: 0937520520) and finally inputs the birth month and day of the person (step S25, picture P25: October 21). After completing the data input (step S26, picture P26), the cellular phone is back to the idle mode.

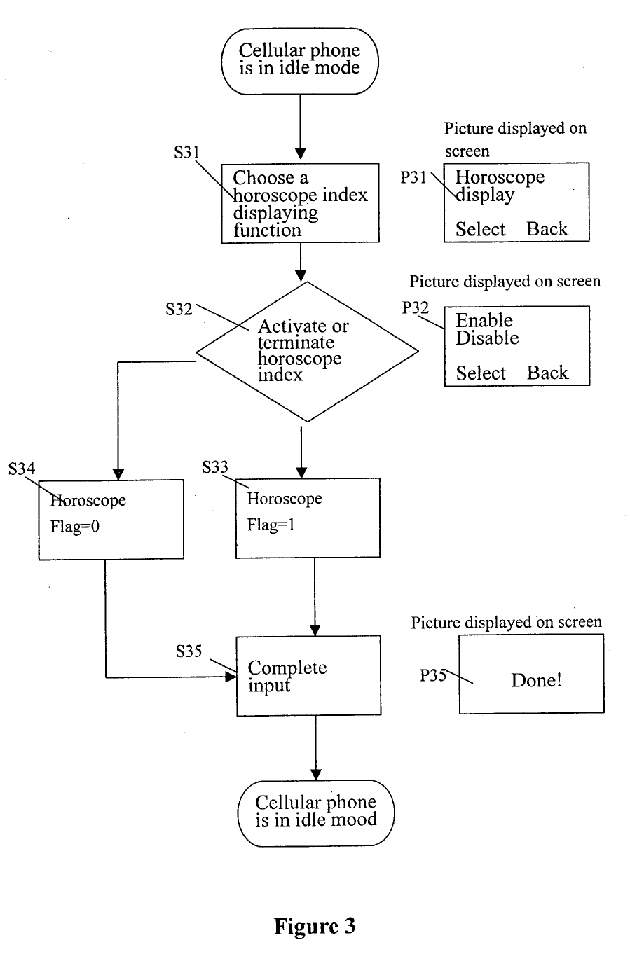

Now refer to FIG. 3. FIG. 3 is a flow chart showing steps for either activating or deactivating the function showing a caller's horoscope index, in which a picture displayed on the screen accompanied with the each corresponding step is also shown in the figure. First, a cellular phone is in an idle mode. The user chooses a horoscope index displaying function (step S31, picture P31) to either activate or terminate the function for showing horoscope index (step S32, picture P32: Enable, Disable). If select to activate the function (Enable), a displaying function flag HoroscopeF is equal to 1. If select to terminate the function (Disable), a displaying function flag HoroscopeF is equal to 0. After completing the inputting (step S35, picture P35), the cellular phone is back to the idle mode.

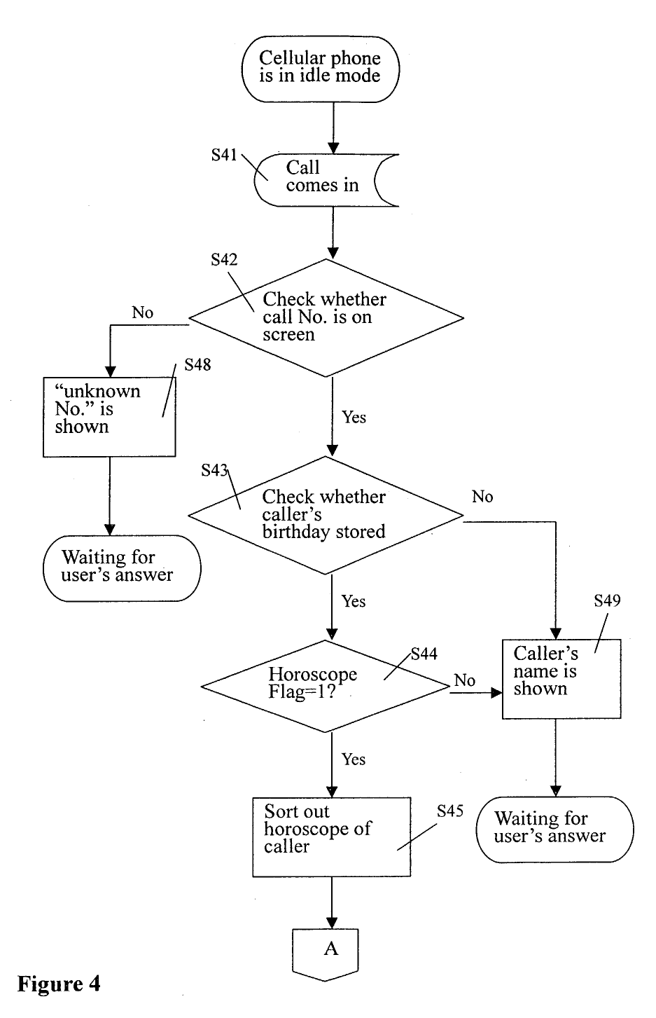

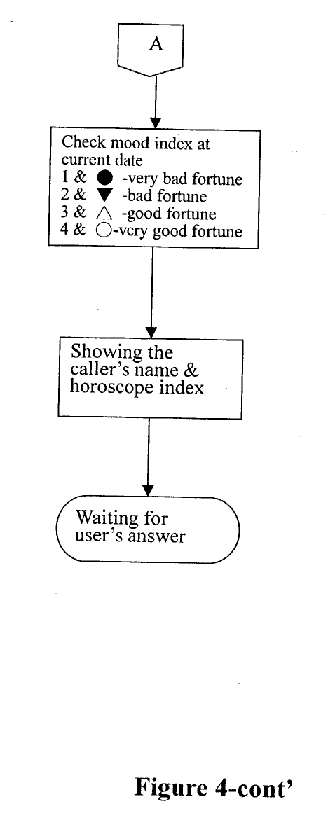

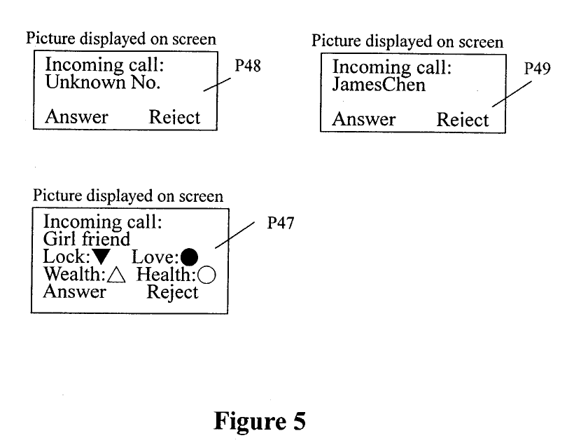

Finally, please refer to FIG. 4. FIG. 4 is a flow chart showing the operation steps of a method for showing a caller's horoscope index in a cellular phone. First, when a phone call comes in (step S41), a cellular phone first checks whether a telephone number is included (step S42). If not, a message “unknown number” is directly shown on the screen (step S48, picture P48: “Unknown number” shown in FIG. 5) to wait for user answering the phone. If yes, the cellular phone further checks whether the birthday of the caller has been stored in the memory (step S42). If not, only the caller's name is shown on the screen (step S49, picture P49: James Chen, as shown in FIG. 5) and the phone call is also waited for the user to answer. If yes, the cellular phone checks whether the function flag HoroscopeF is equal to 1(step 44). If not, it means that the horoscope index function is not activated, thus the cellular phone returns to step S49 to show the caller's name only. If so, the horoscope of the caller can be chosen from the database according to the caller's birth month and day (step S45) and then check its horoscope index at the current date (step S46, wherein a picture ● and number 1 represent a very bad fate, a picture ▾ and a number 2 represent a bad fate, a picture Δ and a number 3 represent a good fortune, and a picture ◯ and a number 4 represent a very good fortune). Subsequently, the caller's name and his horoscope index are shown on the screen (Step S47, Picture P47: for example shown as “Lock”, “Love”. “Wealth”, and “Health”). The user could answer the call while the picture being displayed.

Table 1 lists one example of database of daily horoscope index based on horoscope. Of course, the picture showing the horoscope index is not limited in the above four kinds pictures (Lock, Love, Wealth, and Health), the other picture such as showing travel and people relationship can be included.

Although the present invention has been described by the above embodiment, the present invention is not limited by the embodiment. Person skilled in the art would make various changes or modification without departing from the spirit and the scope of the present invention. The present invention is only limited by the appended claims.

TABLE 1

| Month/Day | 1/1 | 1/2 | 12/30 | 12/31 |
|---|---|---|---|---|
| Aquarius | Luck: 4 | Luck: 3 | Luck: 4 | Luck: 3 |
| 1/21-2/19 | Love: 3 | Love: 3 | Love: 3 | Love: 3 |
| | Wealth: 3 | Wealth: 2 | Wealth: 3 | Wealth: 2 |
| | Health: 1 | Health: 1 | Health: 1 | Health: 1 |
| Pisces | Luck: 3 | Luck: 2 | Luck: 3 | Luck: 2 |
| 2/20-3/20 | Love: 3 | Love: 3 | Love: 3 | Love: 3 |
| | Wealth: 2 | Wealth: 2 | Wealth: 2 | Wealth: 2 |
| | Health: 1 | Health: 1 | Health: 1 | Health: 1 |
| Aries | Luck: 2 | Luck: 4 | Luck: 2 | Luck: 4 |
| 3/21-4/20 | Love: 3 | Love: 3 | Love: 3 | Love: 3 |
| | Wealth: 2 | Wealth: 2 | Wealth: 2 | Wealth: 2 |
| | Health: 1 | Health: 3 | Health: 1 | Health: 3 |
| Taurus | Luck: 4 | Luck: 1 | Luck: 2 | Luck: 1 |
| 4/21-5/21 | Love: 3 | Love: 3 | Love: 3 | Love: 3 |
| | Wealth: 2 | Wealth: 2 | Wealth: 2 | Wealth: 2 |
| | Health: 3 | Health: 1 | Health: 1 | Health: 1 |
| Gemini | Luck: 1 | Luck: 4 | Luck: 3 | Luck: 4 |
| 5/22-6/21 | Love: 3 | Love: 3 | Love: 3 | Love: 3 |
| | Wealth: 2 | Wealth: 3 | Wealth: 2 | Wealth: 3 |
| | Health: 1 | Health: 1 | Health: 1 | Health: 1 |
| Cancer | Luck: 4 | Luck: 3 | Luck: 3 | Luck: 3 |
| 6/22-7/23 | Love: 3 | Love: 3 | Love: 3 | Love: 3 |
| | Wealth: 3 | Wealth: 2 | Wealth: 2 | Wealth: 2 |
| | Health: 1 | Health: 1 | Health: 1 | Health: 1 |
| Leo | Luck: 3 | Luck: 3 | Luck: 2 | Luck: 3 |
| 7/24-8/23 | Love: 3 | Love: 3 | Love: 3 | Love: 3 |
| | Wealth: 2 | Wealth: 2 | Wealth: 2 | Wealth: 2 |
| | Health: 1 | Health: 1 | Health: 1 | Health: 1 |
| Virgo | Luck: 2 | Luck: 2 | Luck: 4 | Luck: 2 |
| 8/24-9/23 | Love: 3 | Love: 3 | Love: 3 | Love: 3 |
| | Wealth: 2 | Wealth: 2 | Wealth: 2 | Wealth: 2 |
| | Health: 1 | Health: 1 | Health: 3 | Health: 1 |
| Libra | Luck: 4 | Luck: 4 | Luck: 1 | Luck: 4 |
| 9/24-10/23 | Love: 3 | Love: 3 | Love: 3 | Love: 3 |
| | Wealth: 2 | Wealth: 2 | Wealth: 2 | Wealth: 2 |
| | Health: 3 | Health: 3 | Health: 1 | Health: 3 |
| Scorpio | Luck: 1 | Luck: 1 | Luck: 4 | Luck: 1 |
| 10/24-11/22 | Love: 3 | Love: 3 | Love: 3 | Love: 3 |
| | Wealth: 2 | Wealth: 2 | Wealth: 3 | Wealth: 2 |
| | Health: 1 | Health: 1 | Health: 1 | Health: 1 |
| Sagitta | Luck: 4 | Luck: 4 | Luck: 3 | Luck: 4 |
| 11/23-12/22 | Love: 3 | Love: 3 | Love: 3 | Love: 3 |
| | Wealth: 3 | Wealth: 3 | Wealth: 2 | Wealth: 3 |
| | Health: 1 | Health: 1 | Health: 1 | Health: 1 |
| Capricorn | Luck: 3 | Luck: 3 | Luck: 1 | Luck: 3 |
| 12/23-1/20 | Love: 3 | Love: 3 | Love: 3 | Love: 3 |
| | Wealth: 2 | Wealth: 2 | Wealth: 2 | Wealth: 2 |
| | Health: 1 | Health: 1 | Health: 1 | Health: 1 |

What is claim is:

1. A method for showing a caller's horoscope index in a cellular phone, which comprises the steps of: establishing a horoscope index database in said cellular phone; storing a caller's birth month and day in said cellular phone; checking a caller's horoscope index according to said caller's birth month and day and a current date by inquiring said horoscope index database stored in said cellular phone; and displaying a picture for representing said caller's horoscope index on a screen of said cellular phone.

2. The method according to claim 1, wherein when a user adds new friend's data in said cellular phone; a friend's birthday can be also added and stored.

3. The method according to claim 1, wherein said caller's birth month and day is checked to select what horoscope the caller belongs to then a horoscope index is inquired in a database according to a current date.

4. The method according to claim 1 or 3, wherein said horoscope index is shown as a number.

5. The method according to claim 4, wherein said number is 1, 2, 3, or 4; the number 1 represents very bad fate, 2 represents bad fate, 3 represents good fortune, and 4 represents very good fortune.

6. The method according to claim 1, wherein the horoscope index is shown in one of following pictures: ^{┌}●_{┘}, ^{┌}▾_{┘}, ⁵³⁹ Δ_{┘}, and ⁵³⁹ ◯₅₄₀ , the picture ⁵³⁹ ●₅₄₀ represents a very bad fate, the picture ⁵³⁹ ▾₅₄₀ represents a bad fate, the picture ^{┌}Δ₅₄₀ represents a good fortune, and the picture ⁵³⁹ ◯₅₄₀ represents a very good fortune.

7. A cellular phone capable showing a caller's horoscope index, comprising a central processing unit (CPU), memory, radio frequency module, displaying screen, keyboard, speaker, microphone, and antenna; besides, said cellular phone further including a horoscope index database, said database is used for storing a caller's name, telephone number, and birthday, and said central processing unit inquires a horoscope index stored in said database according to said caller's birth month and day.

8. The cellular phone according to claim 7, wherein said horoscope index is displayed as a picture on said displaying screen.

9. The cellular phone according to claim 7, wherein the displaying function of said horoscope index is activated or deactivated by a user.

10. The cellular phone according to claim 7, wherein the central processing unit can process the following logic judgment:
(1) checking whether a caller's phone number is displayed on said screen;
(2) checking whether a caller's birthday is stored in said database; and
(3) activating a displaying function for showing said caller's horoscope index.

11. The cellular phone according to claim 10, wherein said displaying function for showing a horoscope index is operated by the following procedures: checking said caller's birth month and day to select what horoscope said caller belongs to and then check said horoscope index at current date, and displaying a picture representing said horoscope index on said displaying screen.
